(19) United States
(12) Patent Application Publication
(10) Pub. No.: US 2011/0022307 A1
(43) Pub. Date: Jan. 27, 2011

(54) METHOD FOR OPERATING NAVIGATION FRAME, NAVIGATION APPARATUS AND RECORDING MEDIUM

(75) Inventor: Yu-Cheng Lee, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/843,859

(22) Filed: Jul. 26, 2010

Related U.S. Application Data
(60) Provisional application No. 61/228,957, filed on Jul. 27, 2009.

(30) Foreign Application Priority Data
Dec. 31, 2009 (TW) 98146647

(51) Int. Cl. G01C 21/00; G06F 3/041; G06F 3/044

(52) U.S. Cl. 701/202; 701/200; 345/173; 345/174

(57) ABSTRACT

A method for operating a navigation apparatus, a navigation apparatus, and a recording medium are provided. In the method, a navigation frame is displayed on a touch screen when a navigation mode is entered. The sensitivity of the touch screen is adjusted from an original sensitivity to a preset sensitivity to detect an object appeared in front of the touch screen, in which the preset sensitivity is higher than the original sensitivity. When the touch screen detects the object, a window is operated according to a moving direction of the object relative to the touch screen.

### CROSS-REFERENCE TO RELATED APPLICATION

This application claims the priority benefits of U.S. provisional application No. 61/228,957, filed on Jul. 27, 2009 and Taiwan application serial No. 98146647, filed on Dec. 31, 2009. The entirety of each of the above-mentioned patent applications is hereby incorporated by reference herein and made a part of this specification.

### BACKGROUND

The conventional navigation apparatus has a built-in smart electronic map and can execute functions of route planning and navigation. The user is only required to input a name or a coordinate of a destination to be leave for, or directly select a particular location on the electronic map, and then the navigation apparatus automatically plans a navigation route based on the detected current location and a geographical location of the destination input by the user, and delivers a voice message to guide the user to the destination according to the planned navigation route.

In the process of the navigation software displaying the map in the full-screen mode, the mobile device may still receive an incoming call, a short message, an instant message, or an email from outside. At this time, if the user wants to response such external events, or needs to make a call or operate other functions of the mobile device, generally the user has to select a specific key to open a window, so as to perform operations within the window.

However, aforesaid method for opening or operating a window requires the user to watch the screen of the mobile device and select a function key on the screen, so as to complete an operation, which may cause inconvenience for the driver, and the distraction resulting from watching the screen may also jeopardize the safety of the driver. Therefore, there is a need to provide a method for operating the navigation apparatus for the user to perform operations on the navigation frame without watching the screen.

### SUMMARY

The application is directed to a method for operating a navigation apparatus, by which the sensitivity of the touch screen is increased to detect a gesture of a user in front of the touch screen, so as to perform operations on the navigation frame.

The application is directed to a navigation apparatus, which detects an object in front of a touch screen and opens, switches, or closes a window according to the moving direction of the object.

The application provides a method for operating a navigation apparatus in a navigation mode, which is suitable for a mobile device having a touch screen. In the method, a navigation frame is displayed on a touch screen when a navigation mode is entered. A sensitivity of the touch screen is adjusted to a preset sensitivity so as to detect an object appeared in front of the touch screen, in which the preset sensitivity is higher than an original sensitivity of the touch screen. When the touch screen detects the object, a window is operated according to a moving direction of the object relative to the touch screen.

In one example of the application, before displaying the navigation frame, the method further comprises detecting a current location of the mobile device and receiving a destination so as to plan a navigation route by using the current location of the mobile device as a start point and using the destination as an end point. Then, an electronic map nearby the navigation route is accessed and the navigation route is marked on the electronic map, so as to generate the navigation frame.

In one example of the application, the step of displaying the navigation frame comprises displaying in a full-screen mode.

In one example of the application, the step of adjusting the sensitivity of the touch screen to the preset sensitivity so as to detect the object in front of the touch screen comprises adjusting a signal-to-noise ratio (SNR) of the touch screen to enable the touch screen to detect the object in front of the touch screen.

In one example of the application, the step of detecting the object in front of the touch screen comprises detecting a capacitance of each of a plurality of touch points in the touch screen, and determining whether there is an object appeared in front of the touch screen according to a variance of the capacitance of each of the touch points.

In one example of the application, the step of determining whether there is an object appeared in front of the touch screen according to the variance of the capacitance of each of the touch points comprises comparing the variance of the capacitance of each of the touch points within a unit of time with a variance threshold, determining there is an object in front of the touch point of the touch screen if the variance of the touch point is larger than or equal to the variance threshold, and determining there is no object in front of the touch point of the touch screen if the variance of the touch point is less than the variance threshold.

In one example of the application, the step of displaying the window on the navigation frame according to the moving direction of the object relative to the touch screen comprises calculating a distance between the object in front of the touch point of the touch screen and the touch point according to the capacitance of each of the touch points and determining the moving direction of the object relative to touch screen according to a variance of the distance between the object and each of the touch points.

In one example of the application, the aforesaid object is a conductive object.

In one example of the application, when the object comprises moving in a first direction perpendicular to the touch screen, then the window is opened on the navigation frame.

In one example of the application, after opening and displaying the window on the navigation frame, the method further comprises continuing to detect the object and determine the moving direction of the object relative to the touch screen, in which when the object is moved in the first direction perpendicular to the touch screen, a first operation function of the window is executed, and when the object is moved in a second direction parallel to the touch screen, then a second operation function of the window is executed.

In one example of the application, the aforesaid window is a menu having at least one item and one of the items in the window is marked as a current item.

In one example of the application, the aforesaid window is a menu having at least one item and only a current item in the at least one items is displayed in the window.

In one example of the application, the step of executing the first operation function comprises executing a function of a current item or displaying a submenu of the current item, and the step of executing the second operation function comprises switching the current item to a next item in the menu.

In one example of the application, the menu comprises a return item and an exit item and the step of executing the first operation function comprises executing the return item to return to a previous menu of the current menu or executing the exit item to close the menu.

In one example of the application, after displaying the window, the method further comprises accumulating a lasting time for displaying the window and comparing the same with a time threshold, in which when the lasting time exceeds the time threshold, the window is closed accordingly.

The application provides a navigation apparatus, which comprises a touch screen, a storage unit, and a processing unit. The touch screen has a sensitivity and is used for displaying a navigation frame. The storage unit is used for storing an electronic map. The processing unit is coupled to the touch screen and the storage unit, and is used for displaying the navigation frame on the touch screen when a navigation mode is entered and adjusting the sensitivity of the touch screen to a preset sensitivity to detect an object in front of the touch screen, in which the preset sensitivity is higher than an original sensitivity of the touch screen. When the touch screen detects the object, a window is displayed on the navigation frame according to a moving direction of the object relative to the touch screen.

The present application further provides a recording medium which records a computer program to be loaded into a mobile device to execute following steps. A navigation frame is displayed on a touch screen when a navigation mode is entered. A sensitivity of the touch screen is adjusted to a preset sensitivity so as to detect an object appeared in front of the touch screen, in which the preset sensitivity is higher than an original sensitivity of the touch screen. When the touch screen detects the object, a window is displayed on the navigation frame according to a moving direction of the object relative to the touch screen.

Based on the above, the method for operating a navigation apparatus, the navigation apparatus, and the recording medium detect the object in front of the touch screen through increasing the sensitivity of the touch screen when the mobile device enters a navigation mode. Accordingly, based on the moving direction of the object, a window is opened, switched, or closed on the navigation frame, thus providing users with ease to operate functions of the navigation apparatus on the navigation frame.

In order to make the aforementioned and other features and advantages of the application more comprehensible, examples accompanying figures are described in detail below.

### BRIEF DESCRIPTION OF THE DRAWINGS

The accompanying drawings are included to provide a further understanding of the application, and are incorporated in and constitute a part of this specification. The drawings illustrate examples of the application and, together with the description, serve to explain the principles of the application.

FIG. 1 is a block diagram of a navigation apparatus according to an example of the present application.

FIG. 2 is a flowchart showing the method for operating the navigation apparatus in a navigation mode according to an example of the present application.

FIG. 3 is a flowchart showing the method for operating the navigation apparatus in a navigation mode according to an example of the present application.

FIGS. 4A to 4D show an example of a method for operating the navigation apparatus according to an example of the application.

FIGS. 5A to 5C show an example of a method for operating the navigation apparatus according to an example of the application.

### DESCRIPTION OF EXAMPLES

When entering a navigation mode, the mobile device of the application not only displays a navigation frame, but also increases a sensitivity of the touch screen to enable the touch screen to detect an approaching gesture or a waving gesture of a user in front of the touch screen. The mobile device also opens, switches, or closes a window according a moving direction of the gesture. Therefore, the application may provide users with a convenient and intuitive way to operate functions of the navigation apparatus on the navigation frame without affecting the safety for driving.

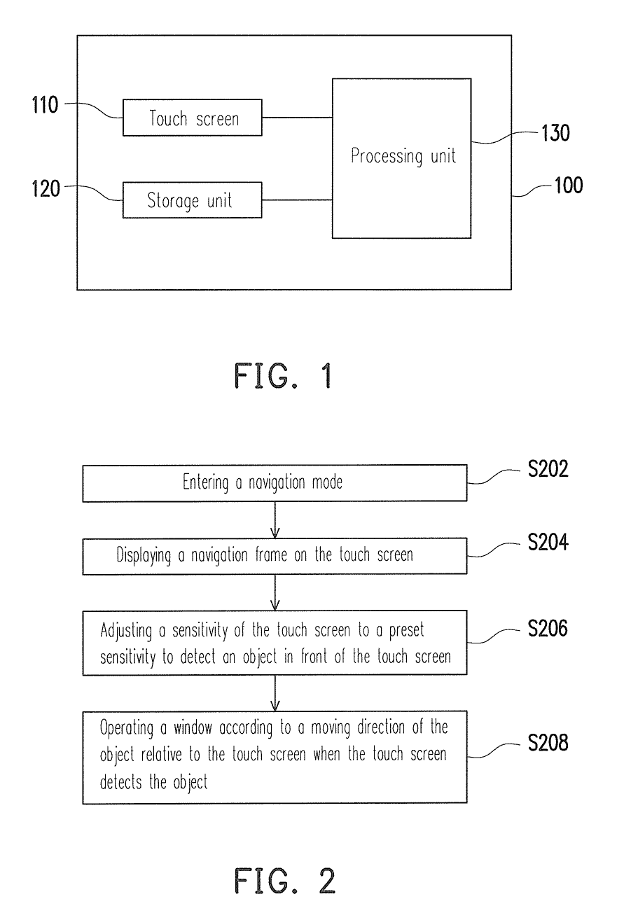

FIG. 1 is a block diagram of a navigation apparatus according to an example of the present application. Referring to FIG. 1, the navigation apparatus 100 comprises a touch screen 110, a storage unit 120, and a processing unit 130, and is able to perform operations on a navigation frame according to a gesture of a user in front of the touch screen when entering a navigation mode and displaying the navigation frame. The navigation apparatus 100 is a mobile device such as a mobile phone, a smartphone, a personal digital assistance (PDA), a PDA phone, a car PC, a notebook, a multimedia player, or a handheld game device, which is not limited thereto. The functions of aforesaid elements are respectively illustrated as follows.

The touch screen 110 is, for example, a surface capacitive touch (SCT) screen or a projected capacitive touch (PCT) screen, and a sensitivity of the touch screen 110 may be adjusted to extend its detecting range to the front of its surface without being limited to physically touching the surface. The sensitivity of the touch screen 110 may be adjusted, for example, through adjusting a signal-to-noise ratio (SNR) of the touch screen 110. Accordingly, the touch screen 110 is able to detect an object (e.g. conductive object) appeared within a certain distance in front of its surface.

The storage unit 120 is, for example, any one of a fixed or non-fixed random access memory (RAM), a read-only memory (ROM), a flash memory, a hard disk, or other similar devices or a combination of those devices, and is used for storing an electronic map for navigation. Alternatively, the electronic map may be an electronic map in the internet or an electronic map for online navigation, and is temporarily stored in the storage unit 120.

The processing unit 130 is, for example, a central processing unit (CPU), or other programmable ordinarily-used or specifically-used microprocessor, digital signal processor (DSP), programmable controller, application specific integrated circuit (ASIC), programmable logic device (PLD), or other similar devices or a combination of those devices.

The processing 130 is coupled to the touch screen 110 and the storage unit 120, and is used for detecting an approaching gesture or a waving gesture of a user in front of the touch screen 110 and accordingly displaying or switching a window on the navigation frame. Examples are given below for illustrating detailed steps of the method for operating the navigation apparatus.

FIG. 2 is a flowchart showing the method for operating the navigation apparatus in a navigation mode according to an example of the present application. Referring to FIG. 2, the method of the example is suitable for the navigation apparatus 100 in FIG. 1 and detailed steps of the navigation apparatus operating method of the application are described in detail below with reference to the aforesaid elements of the navigation apparatus 100.

When the navigation apparatus 100 receives an instruction for selecting a navigation function from a user, the processing unit controls the navigation apparatus 100 to enter a navigation mode (step S202) and displaying a navigation frame on the touch screen 110 (step S204). The navigation apparatus 100, for example, detects a current location thereof by using a positioning unit (not shown), receives a start point and an end point input by the user by using the touch screen 110, and plans a navigation route according the start point and the end point by using the processing unit 130. Then, the processing unit 130 accesses the storage unit 120 to obtain an electronic map nearby the navigation route and finally marks the navigation route on the electronic map to generate the navigation frame.

In detail, the aforesaid start point is, for example, the current location of the navigation apparatus 100 detected by the positioning unit (not shown), a location corresponding to a coordinate or an address input by the user, or a point of interest (POI) selected from a POI list by the user. The end point is, for example, a location corresponding to the coordinate or the address input by the user or a POI selected from a POI list by the user, which is not limited herein. The positioning unit (not shown) is, for example, a global positioning system (GPS), or other communication systems using a global system for mobile communication (GSM) system, a personal handy-phone system (PHS), a code division multiple access (CDMA) system, a wireless fidelity (Wi-Fi) system, a worldwide interoperability for microwave access (WiMAX) system, a radio repeater, or a radio broadcaster for positioning, and is used for obtaining the current location of the navigation apparatus 100.

The navigation apparatus 100, for example, displays the navigation frame in a full-screen mode when entering the navigation mode. To provide the user with ease to operate the navigation apparatus 100 without watching the touch screen 110, when the navigation apparatus 100 displays the navigation frame, the processing unit 130 adjusts the sensitivity of the touch screen 110 from an original sensitivity to a preset sensitivity, so as to enable the touch screen to detect the object in front of the surface thereof (step S206). That means when the sensitivity of the touch screen 110 is kept in the original sensitivity, the user has to touch the touch screen 110 so as to operate the navigation apparatus 100; when the sensitivity of the touch screen is adjusted to the preset sensitivity, the user may operate the touch screen 110 without directly touching the touch screen 110. The aforesaid preset sensitivity is higher than the original sensitivity of the touch screen 110, such that a detecting range of the touch screen 110 may be extended from its surface to a certain distance in front of its surface. In one example, if the touch screen 110 is a capacitive touch screen, the aforesaid sensitivity is, for example, a noise or a SNR of the touch screen 110. When the navigation apparatus 100 increases the noise of the touch screen 110 or reduces the SNR of the touch screen 110, the touch screen 110 is able to extend its detecting range to a certain distance in front of its surface.

In detail, after adjusting the sensitivity of the touch screen 110, the processing unit 130, for example, detects a capacitance of each of the touch points in the touch screen 110 and determines whether there is an object in front of the touch screen 110 according to a variation of the capacitance of each of the touch points. The processing unit 130, for example, compares the variation of each touch point within a unit of time with a variation threshold, so as to determine whether an object is existed. If the variation of the touch point is larger than or equal to the variation threshold, the processing unit 130 determines that there is an object in front of the touch point of the touch screen 110. On the contrary, if the variation of the touch point is less than the variation threshold, the processing unit 130 determines there is no object in front of the touch point of the touch screen 110.

When the touch screen detects the object, the processing unit 130 displays a window on the navigation frame according to a moving direction of the object relative to the touch screen (step S208). The method that the processing unit 130 detects the object is, for example, to calculate a distance between the touch point and the object according to the capacitance of each of the touch points, and collects all the distance data between the touch points and the object, so as to predict the location of the object in front of the touch screen 110.

In addition, the processing unit 130 may further determine a moving direction of the object relative to the touch screen 110 according to a variation of the distance between each touch point and the object. When the object is determined to be moved in a first direction perpendicular to the touch screen 110, the processing unit 130 accordingly opens and displays a window (e.g. an operation window or a browsing window) on the navigation frame, in which the first direction is, for example, a direction toward the touch screen 110.

In detail, according to the operation habit of users, the simplest and most intuitive way is to approach the screen by a finger. Therefore, after increasing the sensitivity of the touch screen 110, the navigation apparatus 100 of the application is able to detect the “approaching gesture” of the user, so as to open the window on the navigation frame displayed by the touch screen 110 and provide the same for the user to perform subsequent operations. Specifically, besides approaching the screen by the finger, the user may also approach the screen by the palm of the hand to make the approaching gesture, which is not limited herein.

It should be noted herein that since the gesture of the user is not always moved in the direction exactly perpendicular to the touch screen, the first direction perpendicular to the touch screen 110 described herein only indicates an approximate direction and may tolerate certain deviation. Once the portion of the movement of the object in the direction perpendicular to the touch screen 110 is larger than a certain value, it is determined that the object is moved in the direction perpendicular to the touch screen 110.

Beside the aforesaid direction perpendicular to the touch screen 110, the application also combines other gestures of the user in front of the touch screen 110, so as to provide functions such as opening, switching, returning, or closing a window; opening, entering, switching, returning, or closing a menu; or executing an instruction. Examples are given below for further illustration.

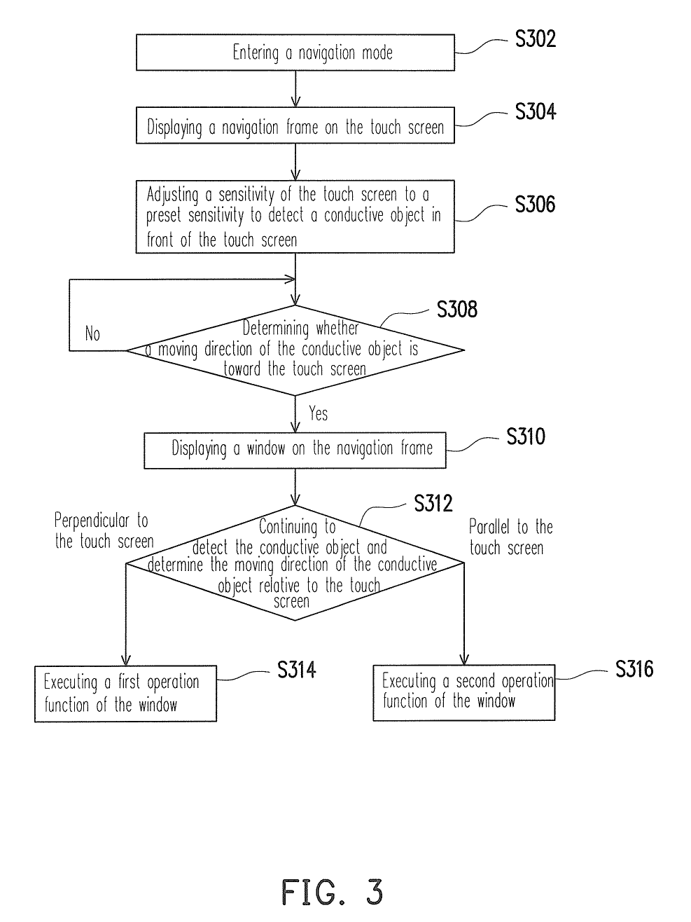

FIG. 3 is a flowchart showing the method for operating the navigation apparatus in a navigation mode according to an example of the present application. Referring to FIG. 3, the method of the example is suitable for the navigation apparatus 100 in FIG. 1 and detailed steps of the navigation apparatus operating method of the application are described in detail below with reference to the aforesaid elements of the navigation apparatus 100.

When the navigation apparatus 100 receives an instruction of a user for selecting the navigation function, the processing unit 130 controls the navigation apparatus 100 to enter a navigation mode (step S302) and displaying a navigation frame on the touch screen 110 (step S304). When the navigation apparatus 100 displays the navigation frame, the processing unit 130 adjusts a sensitivity of the touch screen 110 to a preset sensitivity to enable the touch screen 110 to detect a conductive object in front of the surface thereof (step S306). The detailed content of the above steps S302-S306 are all identical or similar to the steps S202-S206 in the above example, and will not be described herein.

The difference between the present example and the previous example is that, in the present example, when an conductive object is detected by the touch screen 110 of the navigation apparatus, the processing unit 130 further determines whether a moving direction of the conductive object is toward the touch screen 110 (step S308). If the moving direction of the conductive object is not toward the touch screen 110, the processing unit performs no actions but keeps detecting the moving direction of the object (step S306); on the contrary, if the moving direction of the object is toward the touch screen 110, the processing unit 130 displays a window on the navigation frame (step S310).

After displaying the window, the navigation apparatus 100 still keeps detecting the object by using the touch screen 110, and the processing unit 130 determines the moving direction of the conductive object relative to the touch screen 110 (step S312). When the conductive object is moved in a first direction perpendicular to the touch screen 110, the processing unit 130 executes a first operation function of the window (step S314). When the conductive object is moved in a second direction parallel to the touch screen, the processing unit 130 executes a second operation function of the window (step S316). In detail, to precisely determine the gesture made by the user, the present example only classifies the gestures of the user into an approaching gesture and a waving gesture, in which the two kinds of gestures are corresponding to different operation functions.

For example, the window displayed on the navigation frame by the processing unit 130 is a menu having at least one item. If the menu comprises more than one item, one of the items (e.g. a first item in the menu or an item selected before the menu is closed for the last time) is marked to represent a currently selected item according to a setting of the navigation apparatus 100. In another example, the window displayed on the navigation frame by the processing unit 130 may comprise only a current item of the at least one item of the menu, which is not limited thereto.

When the user performs the gesture in front of the touch screen 110 again, the processing unit 130 determines whether to execute a function corresponding to the current item or switch to a next item according to the moving direction of the gesture, and if the menu comprises another layer of menu under the current item, the processing unit 130 displays a submenu of the current item. For example, when the user's gesture is moved by means of approaching the touch screen 110, the processing unit 130 executes a function corresponding to the current item or displays the submenu in a next layer of the current item, and when the user's gesture is moved in a direction parallel to the touch screen 110 (e.g. a specific direction such as a direction from left to right, from right to left, from up to down, from down to up, or from lower right to upper left; or any direction parallel to the touch screen 110.), the processing unit 130 switches the currently marked item to a next item.

Through aforesaid operation method, the user may operating a function of the navigation apparatus 100 on the navigation frame through waving finger or palm in front of the touch screen 110 without physically touching the touch screen 110 or touching specific keys displayed on the touch screen 110. When opening or switching the window, the navigation apparatus 100 may also send a voice message to inform the user of the currently opened menu or currently selected item. Accordingly, the user may operate the function of the navigation apparatus 100 on the navigation frame without watching the touch screen 110, so as to prevent the danger raised due to the distraction resulting from watching the screen.

It should be noted herein that, in the present example, a return item and an exit item may be further defined in the menu displayed by the navigation apparatus 100, such that the user may control the navigation apparatus 100 to switch to the return item or the exit item through a waving gesture, control the navigation apparatus 100 to execute the return item to return to a previous menu of a multi-layered menu through an approaching gesture, or control the navigation apparatus 100 to execute the exit item to close the menu through the approaching gesture. In addition, after displaying the window, the navigation apparatus 100 may accumulate a lasting time for displaying the window and compare the accumulated lasting time with a time threshold. When the lasting time exceeds the time threshold, the processing unit 130 closes the window so as to resume the originally displayed navigation frame. The aforesaid operating means may be set or disposed by the user or the designer of the navigation apparatus 100, which is not limited by the application.

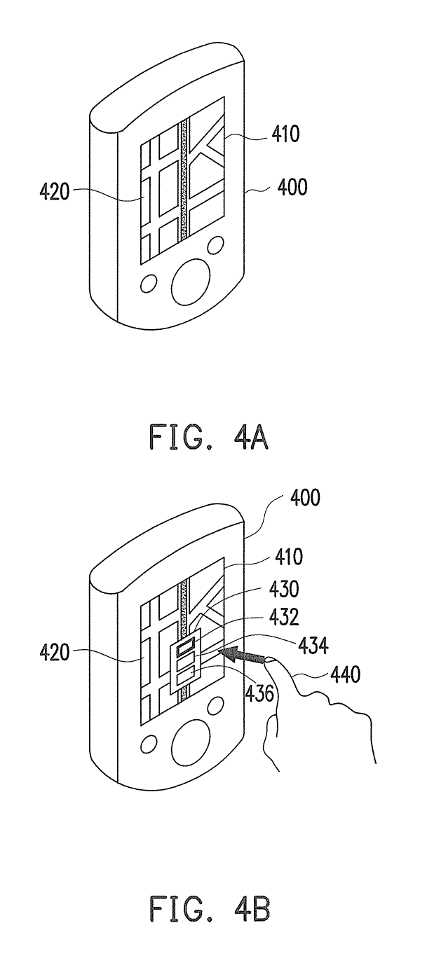

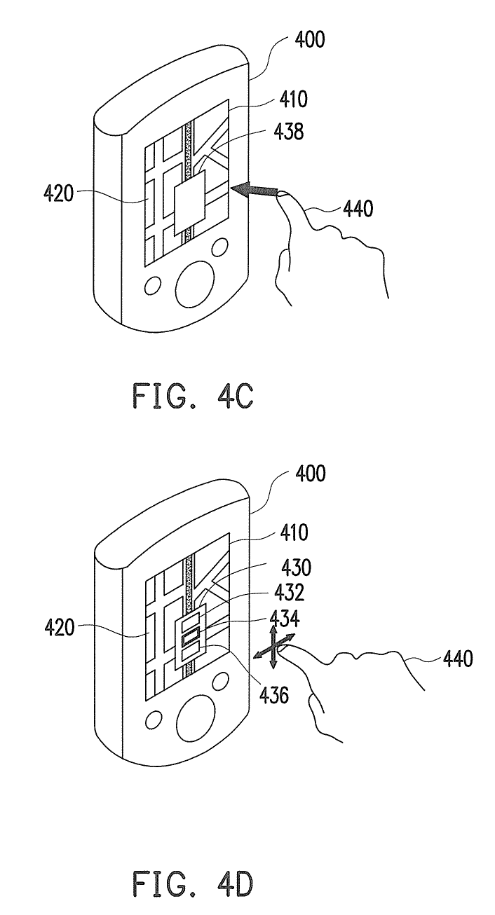

For example, FIGS. 4A to 4D show an example of a method for operating the navigation apparatus according to an example of the application. In the present example, the navigation apparatus 400 displays the navigation frame 420 (as shown in FIG. 4A) on the touch screen 410 in a full-screen mode when entering the navigation mode. At this moment, if the user makes a gesture of approaching the touch screen 410 with finger 440, the navigation apparatus 400 may open a menu 430 (as shown in FIG. 4B) on the navigation frame 420. The menu 430 comprises items 432, 434, and 436, and the item 432 is marked by a thick frame to represent a preset item. At this moment, if the user makes a gesture of approaching the touch screen 410 with his finger 440 again (as shown in FIG. 4C), the navigation apparatus 400 executes a function corresponding to the item 432 such as opening a submenu of the item 432. On the other hand, if the user makes a gesture of waving in a direction parallel to the touch screen 410 with finger 440 (as shown in FIG. 4D), the navigation apparatus switches the marked item from the item 432 to the item 434.

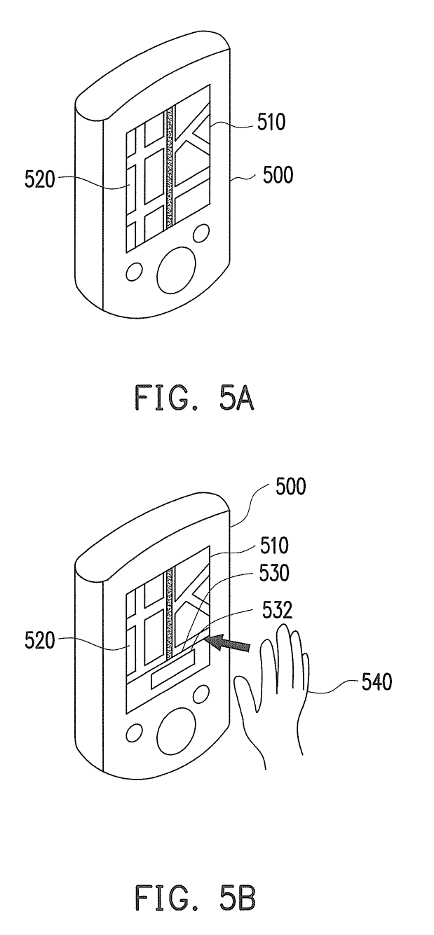

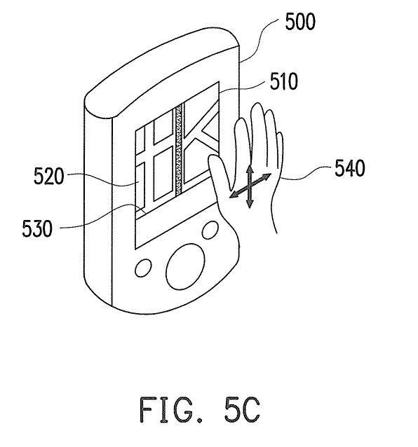

On the other hand, FIGS. 5A to 5C show an example of a method for operating the navigation apparatus according to an example of the application. In the present example, the navigation apparatus 500 displays the navigation frame 520 (as shown in FIG. 5A) on the touch screen 510 in a full-screen mode when entering the navigation mode. At this moment, if the user makes a gesture of approaching the touch screen 110 with palm 540, the navigation apparatus 500 may open a menu 530 in a lower part of the navigation frame 520 (as shown in FIG. 5B), in which the menu 530 comprises an item 532. At this moment, if the user makes a gesture of approaching the touch screen 510 with palm 540 again, the navigation apparatus 500 opens a submenu 534 of the item 532 (as shown in FIG. 5C).

The aforesaid examples summarize a manner that a user opens a window on the navigation frame and performs an operation on the window, which is suitable for the operation actively performed by the user. However, in another example, the navigation apparatus 100 may automatically opens the window on the navigation frame when receiving an incoming call, a short message, or an email from the outside. At this moment, the user may also take use of a method similar to the operating method as described in above examples, so as to perform operation on the window opened by the navigation apparatus 100, such that the effectiveness of touchless operation of the application may be achieved. For example, when the navigation apparatus receives an incoming call from outside, if the user makes a gesture of approaching the touch screen, then the call is answered; on the other hand, if the user makes a gesture of waving in a direction parallel to the touch screen, the call is hanged up. Further, when the navigation apparatus receives a short message or an email from outside, if the user makes a gesture of approaching the touch screen, then the new short message or the new email is read; on the other hand, if the user makes a gesture of waving in a direction parallel to the touch screen, a next short message or a next email is read, or an exit item is executed so as to close the function of reading the short message or the email.

The present application further provides a recording medium which records a computer program to be loaded into a mobile device to execute the method for operating a navigation apparatus as described above. The computer program is composed of a plurality of program instructions (for example, an organization chart establishing program instruction, a table approving program instruction, a setting program instruction, and a deployment program instruction, etc), and these program instructions are loaded into the mobile device and executed by the same to accomplish various steps in the method for operating a navigation apparatus and various functions of the navigation apparatus described above.

To sum up, the method for operating the navigation apparatus, the navigation apparatus, and the recording medium of the application provide an intuitive and convenient way for the user to operate the navigation apparatus under the condition that the user activates the navigation function but has no time to watch the screen. The application may open a window or execute a function of an item by detecting an approaching gesture of the user's finger or palm; and switch among the items of a menu by detecting a waving gesture of the user's finger or palm. Accordingly, the application provides users with ease to operate the navigation apparatus on the navigation frame without watching the screen, so as to prevent from the danger caused by watching the screen while driving.

Although the application has been described with reference to the above examples, it will be apparent to one of the ordinary skill in the art that modifications to the described example may be made without departing from the spirit of the application. Accordingly, the scope of the application will be defined by the attached claims not by the above detailed descriptions.

What is claimed is:

1. A method for operating a navigation apparatus, suitable for a mobile device having a touch screen, the method comprising:
entering a navigation mode;
displaying a navigation frame on the touch screen;
adjusting a sensitivity of the touch screen to a preset sensitivity to detect an object in front of the touch screen, wherein the preset sensitivity is higher than an original sensitivity of the touch screen; and
operating a window according to a moving direction of the object relative to the touch screen when the touch screen detects the object.

2. The method of claim 1, wherein the step of adjusting the sensitivity of the touch screen to the preset sensitivity to detect the object in front of the touch screen comprises:
adjusting a signal-to-noise ratio (SNR) of the touch screen to enable the touch screen to detect the object in front of the touch screen.

3. The method of claim 1, wherein the step of detecting the object in front of the touch screen comprises:
detecting a capacitance of each of a plurality of touch points in the touch screen; and
determining whether there is an object in front of the touch screen according to a variance of the capacitance of each of the touch points.

4. The method of claim 3, wherein the step of determining whether there is the object in front of the touch screen according to the variance of the capacitance of each of the touch points comprises:
comparing the variance of the capacitance of each of the touch points within a unit of time with a variance threshold;
determining there is the object in front of the touch point of the touch screen if the variance of the touch point is larger than or equal to the variance threshold; and
determining there is no object in front of the touch point of the touch screen if the variance of the touch point is less than the variance threshold.

5. The method of claim 3, wherein the step of operating the window according to the moving direction of the object relative to the touch screen comprises:
calculating a distance between the object in front of the touch point of the touch screen and the touch point according to the capacitance of each of the touch points;
determining the moving direction of the object relative to touch screen according to a variance of the distance between the object and each of the touch points; and
opening the window on the navigation frame when the object comprises moving in a first direction perpendicular to the touch screen.

6. The method of claim 5, wherein after the step of opening the window on the navigation frame, the method further comprises:
continuing to detect the object and determine the moving direction of the object relative to the touch screen;
executing a first operation function of the window when the object is moved in the first direction perpendicular to the touch screen; and
executing a second operation function of the window when the object is moved in a second direction parallel to the touch screen.

7. The method of claim 1, wherein the window comprises a menu having at least one item and only a current item in the at least one item is displayed in the window.

8. A recording medium, recording program instructions for:
entering a navigation mode;
displaying a navigation frame on a touch screen of a mobile device;
adjusting a sensitivity of the touch screen to a preset sensitivity to detect an object in front of the touch screen, wherein the preset sensitivity is higher than an original sensitivity of the touch screen; and
operating a window according to a moving direction of the object relative to the touch screen when the touch screen detects the object.

9. A navigation apparatus, comprising:
a touch screen, having a sensitivity, for displaying a navigation frame;
a storage unit, for storing an electronic map; and
a processing unit, coupled to the touch screen and the storage unit, for displaying the navigation frame on the touch screen when a navigation mode is entered and adjusting the sensitivity of the touch screen to a preset sensitivity to detect an object in front of the touch screen, wherein the preset sensitivity is higher than an original sensitivity of the touch screen, and operating a window according to a moving direction of the object relative to the touch screen when the touch screen detects the object.

10. The navigation apparatus of claim 9, further comprising:
a positioning unit, for detecting a current location of the navigation device, wherein
the processing unit plans a navigation route by using the current location detected by the positioning unit as a start point and using the destination received by the touch screen as an end point, accesses the electronic map nearby the navigation route, and marks the navigation route on the electronic map so as to generate the navigation frame.

11. The navigation apparatus of claim 9, wherein the processing unit comprises adjusting a SNR of the touch screen to enable to the touch screen to detect the object in front of the touch screen.

12. The navigation apparatus of claim 9, wherein the processing unit comprises detecting a capacitance of each of a plurality of touch points in the touch screen and determining whether there is an object in front of the touch screen according to the capacitances of the touch points.

13. The navigation apparatus of claim 12, wherein the processing unit comprises comparing a variance of the capacitance of each of the touch points within a unit of time with a variance threshold, determining there is the object in front of the touch point of the touch screen if the variance of the touch point is larger than or equal to the variance threshold, and determining there is no object in front of the touch point of the touch screen if the variance of the touch point is less than the variance threshold.

14. The navigation apparatus of claim 12, wherein the processing unit comprises calculating a distance between the object in front of the touch point of the touch screen and the touch point according to the capacitance of each of the touch points, and opening the window on the navigation frame when the object comprises moving in a first direction perpendicular to the touch screen.

15. The navigation apparatus of claim 9, wherein the processing unit comprises opening the window on the navigation frame when determining the object comprises moving in a first direction perpendicular to the touch screen.

16. The navigation apparatus of claim 9, wherein the processing unit comprises executing a first operation function of the window when determining the object is moved in the first direction perpendicular to the touch screen, and executing a second operation function of the window when determining the object is moved in a second direction parallel to the touch screen.

17. The navigation apparatus of claim 16, wherein the window comprises a menu having at least one item; and wherein the processing unit comprises executing a function of a current item in the menu or displaying a submenu of the current item when determining the object comprises moving in the first direction perpendicular to the touch screen, and switching the current item to a next item in the at least one item when determining the object comprises moving in the second direction parallel to the touch screen.

18. The navigation apparatus of claim 16, wherein the window comprises a menu comprising a return item and an exit item; and wherein
the processing unit further comprises executing the return item to return to a previous menu of the menu; and
the processing unit further comprises executing the exit item to close the menu.

19. The navigation apparatus of claim 9, wherein after displaying the window, the processing unit further comprises accumulating a lasting time of displaying the window, comparing the lasting time with a time threshold, and closing the window when determining the lasting time exceeds the time threshold.

20. The navigation apparatus of claim 9, wherein the window comprises a menu having at least one item and only a current item in the at least one item is displayed in the window.
